(19) United States
(12) Patent Application Publication
(10) Pub. No.: US 2010/0140016 A1
(43) Pub. Date: Jun. 10, 2010

(54) VEHICLE AND A LIFTING ARM ASSEMBLY

(76) Inventor: Esko Raappana, Siivikkala (FI)

Correspondence Address: OLIFF & BERRIDGE, PLC, P.O. BOX 320850, ALEXANDRIA, VA, 22320-4850, US

(21) Appl. No.: 12/452,755

(22) PCT Filed: Jul. 24, 2007
(86) PCT No.: PCT/FI2007/050435

§ 371 Date: Feb. 19, 2010

(51) Int. Cl. B66F 11/04; B66C 23/42; E06C 5/04; A62C 27/00

(52) U.S. Cl. 182/20; 212/300; 182/69.4; 169/24

(57) ABSTRACT

A vehicle equipped with a lifting arm assembly includes a chassis structure with a cabin and a lifting arm assembly fastened on top of the chassis structure so that it turns around a vertical rotating by a rotating base. For folding, the lifting arm assembly is positioned behind the cabin in two positions. In a rescue vehicle the lifting arm assembly also includes at least an arm that can be outstretched to a standby position on top of the cabin. A third arm is fastened to a second arm to rotate in the vertical direction so that in the transport position of the lifting arm assembly the third arm can be turned under the second arm or next to it, and the rotating base is also positioned under the central part of the second arm when the lifting arm assembly is in the transport position.

### FIELD OF THE INVENTION

The invention relates to a vehicle equipped with a lifting arm assembly. The invention relates to a lifting arm assembly.

### BACKGROUND OF THE INVENTION

In prior art chassis moving on wheels have been equipped with lifting arm assemblies, in other words boom assemblies, cranes, or lifting devices, which are used for various purposes. Especially for rescue purposes there are known lifting arm assemblies placed on a vehicle chassis.

A known example is a vehicle according to publication U.S. Pat. No. 3,498,474, in which a lifting arm assembly is equipped with a cage suitable for lifting persons, as is also disclosed in document JP 61267700. Document U.S. Pat. No. 3,252,542 discloses a rescue vehicle provided with a cage for lifting persons, as is also disclosed in document JP 62065899.

However, prior art apparatus, especially their lifting arm assemblies have restricted usability, wherein their use for several different purposes is problematic. However, suitability for various needs would be necessary, to be able to easily modify the apparatus or change the purpose of use.

Prior art lifting arm assemblies have not been designed for variable uses, but they are primarily optimal for one purpose of use only.

### SUMMARY OF THE INVENTION

One purpose of the invention is to disclose a solution for a lifting arm assembly, which is suitable for a number of different uses. Examples of uses that can be mentioned include fire prevention and rescue vehicles, lifting platforms and lifting devices of construction industry, as well as military applications.

The vehicle and lifting arm assembly according to the invention can be applied in various operations, of which human rescue, fire extinction, as well as cooling, washing and lifting operations, construction and renovation and other operations can be mentioned as examples.

The vehicle according to the invention, equipped with a lifting arm assembly, will be presented in claim 1. The rescue vehicle according to the invention, equipped with a lifting arm assembly, will be presented in claim 8. The vehicle according to the invention, equipped with a lifting arm assembly, will be presented in claim 13. The lifting arm assembly according to the invention will be presented in claim 15.

More detailed embodiments of the invention will be disclosed in the other claims.

Special advantage of a lifting arm assembly according to an embodiment of the invention is its suitable dimensioning and geometry especially in view of transport. When a vehicle comprises a cabin and the lifting arm assembly is positioned behind the cabin, the lifting arm assembly can be turned into two alternative positions for transport, which is useful in view of different operations.

According to an embodiment of the invention, the outermost part of the lifting arm assembly can be turned above the cabin, when the rest of the lifting arm assembly is primarily still in the transport position. This standby position of the outermost part is especially advantageous when extinguishing fire in various situations, as it is possible to rapidly spray for example water for fire extinction from the outermost part to the target.

According to an embodiment of the invention, the outermost part of the lifting arm assembly can also be turned underneath the lifting arm assembly or next to it, for example away from the top of the cabin, wherein the lifting arm assembly becomes compact and it can be transferred even on a lower level than the cabin, if necessary. The advantage is that the lifting arm assembly does not for example determine the overall height of the vehicle, and it is possible to attain a low centre of gravity. Bodyworks are used for example in rescue vehicles and they comprise a space behind the cabin for various tools, devices and equipment.

According to an embodiment of the invention the outermost part of the lifting arm assembly also turns behind the vehicle so that it is possible to fasten a cage thereto for lifting or moving persons. Thus, the outermost part of the folded lifting arm assembly possibly turns into a vertical position, wherein the cage can be positioned on a low level behind the rear of the vehicle. The cage increases the overall length of the vehicle, and the drawbacks caused thereby can be prevented by shortening the bodywork.

The wheelbase of the vehicle and the vehicle itself do not become unnecessarily long, but the vehicle is also easy to handle and agile thanks to the low centre of gravity. The rotating base of the lifting arm assembly is positioned between the wheel shafts, wherein an advantageous weight distribution is attained.

According to an embodiment of the invention the lifting arm assembly, especially its outermost end is equipped with quick clamping means, wherein it is possible to fasten equipment needed at a given time thereto, such as a work cage or a rescue cage, or work modules, such as a spraying, blowing or suction tool, a gripper, a cutter, a spreader or a penetration tool. If the quick clamping means are compatible with the work modules used both in rescue and civilian operations, flexible possibilities of use are attained. Special advantage is attained by a vehicle having a bodywork containing various work modules for different kinds of tasks. The lifting arm assembly is dimensioned in such a manner that the end of the outermost part of the lifting arm assembly reaches these work modules for attachment or release, wherein it is not necessary to move the work modules manually. The work modules can be positioned under the lifting arm assembly, wherein the overall length of the vehicle does not increase unnecessarily. Quick clamping means are also used in cages and work modules, if necessary.

In one embodiment of the invention the folding angles of the various parts of the lifting arm assembly are also so wide that even working under bridges is possible. It is possible to fasten a work cage to the outermost part of the lifting arm assembly, which can be taken in a substantially horizontal position underneath a bridge, the central part of the lifting arm assembly being in a substantially vertical position and the folding basic part arranged on top of the rotating base being arranged to turn sufficiently, over 90 degrees, so that the central part could be transferred sufficiently at the side of the vehicle.

In several embodiments of the invention, advantages are attained by the telescopic function of the lifting arm assembly, wherein the reach increases considerably. The telescopic function is built in the central part of the lifting arm assembly, by means of which it is possible to take the outermost part further away from the vehicle. In the transport position the telescopic structure is in a retracted state, wherein a compact and short construction is attained. In one embodiment a telescopically operating ladder is attached to the side of the parts of the lifting arm assembly for example for rescue purposes.

The lifting arm assembly has such dimensions that the length of the aforementioned basic part, so-called rotating radius is approximately half of the length of the central part. The rotating base, in turn, is positioned in the middle of the lifting arm assembly and its central part, wherein the overall length of the vehicle does not change even though the lifting arm assembly is in a folded position and in different transport positions. There are two transport positions that differ 180 degrees from each other and in which the lifting arm assembly is positioned in parallel to the longitudinal direction of the vehicle. The outermost part, in turn, is shorter than half the length of the central part, so that it is can fold underneath the central part and extend towards the rotating base. If the outermost part is capable of turning at the side of the central part, the outermost part can be slightly longer.

In the transport position the outermost part is located behind the cabin, but in its extended position it is positioned on top of the cabin. If necessary, the outermost part is designed in such a manner that the extended position is also possible when the other parts of the lifting arm assembly are in a folded state, in their lowest position and in the transport position. The basic part is located underneath the central part in the transport position and the lifting arm assembly is also capable of placing itself approximately into the position of an upside down turned letter U.

If necessary, the vehicle is equipped with support legs, if this is necessary in view of the reach and the lifting capability.

### BRIEF DESCRIPTION OF THE DRAWINGS

In the following, the invention will be described in more detail with reference to the appended drawings, in which:

FIGS. 1 and 2 show a side view of a general principle of a vehicle equipped with a lifting arm assembly and two transport positions of the lifting arm assembly,

FIGS. 3 and 4 show the placement of the work modules,

FIGS. 5, 6 and 7 show a rescue vehicle and a lifting arm assembly in the standby position,

FIGS. 8, 9 and 10 show the placement and handling of a cage, and

FIG. 11 shows a lifting arm assembly equipped with an ladder.

### DETAILED DESCRIPTION OF THE INVENTION

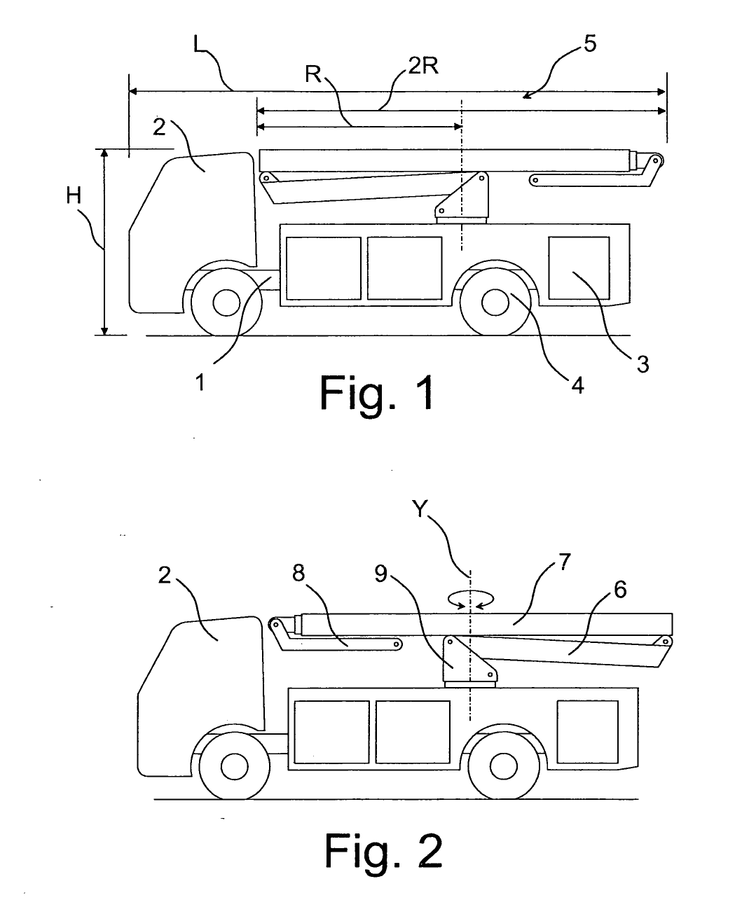

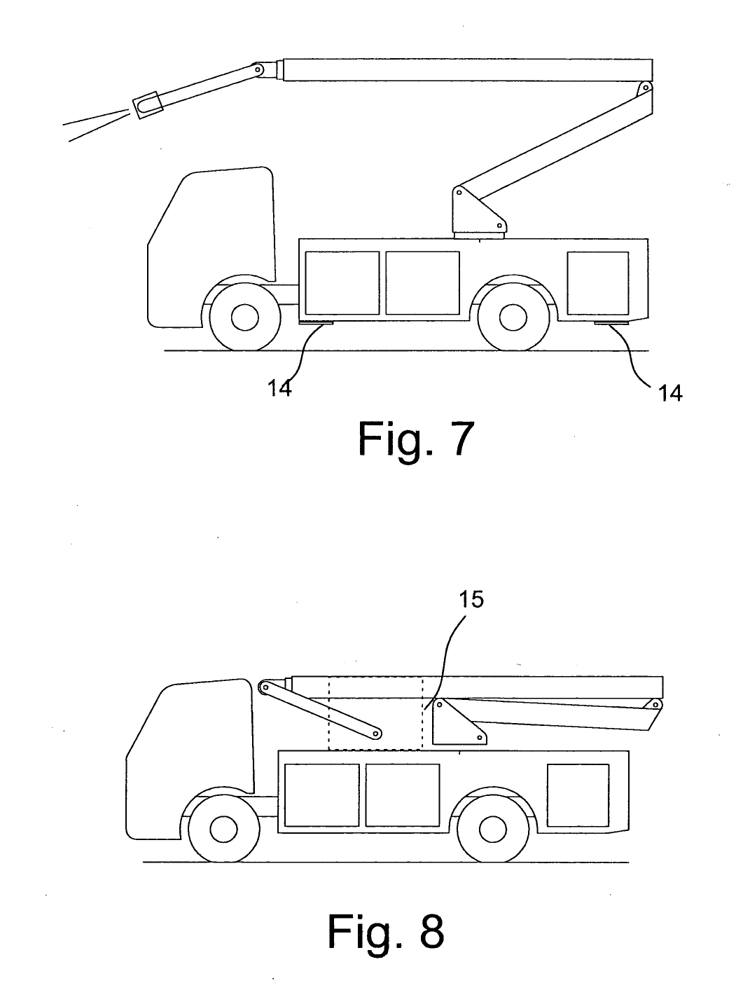

According to FIGS. 1 and 2 the vehicle according to the invention comprises a chassis structure 1 on top of which a cabin 2 is also placed, said cabin being positioned in the front part of the chassis structure. The location, shape and size of the cabin 2 may vary according to the purpose of use, but FIG. 1 shows a conventional chassis structure 1 with a cabin 2. The chassis structure 1 is equipped with a lifting arm assembly 5 according to the invention for the desired purpose of use, said lifting arm assembly being positioned on top of a box body. The box body is positioned on top of the vehicle chassis and together they form the chassis structure 1. In the embodiment of FIG. 1 a bodywork 3 is also positioned around the box body, and it comprises necessary tools and equipment for example for rescue tasks. For the part of the bodywork 3 it is possible to utilize prior art solutions. The chassis structure 1 also contains two or several wheel shafts 4 with wheels. The apparatus, which is also a vehicle, is equipped in a conventional manner with a motor and power transmission. The box body of the chassis structure may be equipped in a known manner with support legs 14 according to FIG. 7, which legs stabilize the vehicle and provide a support point when wide ranges and large loads are in use.

A lifting arm assembly 5 is placed on top of the chassis structure 1, said lifting arm assembly comprising three parts, a first arm 6, also referred to herein as a basic part, a second arm 7, also referred to as a central part and a third arm 8, also referred to as an outermost part. The lifting arm assembly 5 is rotated around a vertical rotating axis Y by means of a rotating base 9. The rotating base 9 comprises the necessary lugs and joint structures so that the first end of the basic part 6 can be fastened thereto in such a manner that the second end of the basic part 6 is capable of ascending and descending when the basic part 6 rotates around a horizontal rotating axis. The vertical rotating movement of the basic part 6 is typically approximately 90 degrees.

The vertical rotating movement of the basic part can also be wider, for example 110 to 120 degrees, wherein it is for example possible to reach with the lifting arm assembly 5 under a bridge on which the vehicle with its lifting arm assembly is located.

The rotating base 9 enables the turning of the lifting arm assembly 360 degrees or unrestrictedly. The lifting arm assembly 5 can be turned in parallel to the vehicle in two different positions according to FIGS. 1 and 2.

The first end of the central part 7 is fastened to the second end of the basic part so that the second end of the central part 7 is capable of ascending and descending when the central part 7 rotates around the horizontal rotating axis. Between the basic part 6 and the central part 7 there are the necessary lugs and joint structures.

The first end of the outermost part 8 is fastened to the second end of the central part 7 so that the second end of the outermost part 8 is capable of ascending and descending when the outermost part 8 rotates around the horizontal rotating axis. Between the outermost part 8 and the central part 7 there are the necessary lugs and joint structures. For the movement there are actuators known as such between the different parts, for example cylinders operating with pressurized hydraulic fluid. More detailed placement of the actuators, as well as their dimensions vary, which, however, is obvious for a person skilled in the art.

Typically the central part 7 is telescopic, having 3 or 4 parts with two or three moving extensions. As for one dimension, the range of the lifting arm assembly sideways is 17 to 20 meters and the working height 23 to 27 meters. Despite of its compact structure, the lifting arm 5 assembly is strong, and according to one example, its load-bearing capacity even exceeds 20 tonne-meters.

In FIGS. 1 and 2 the lifting arm assembly is in the transport position, wherein it is in a folded state and at its lowest. In the presented embodiment the height H of the lifting arm assembly 5 is the same as the height of the cabin 2, wherein a compact structure is attained. For the purpose of folding into the transport position the lifting arm assembly 5 is dimensioned in such a manner that it is positioned behind the cabin 2 in those two positions in which the lifting arm assembly 5 extends in parallel to the longitudinal axis of the vehicle, either forward in accordance with FIG. 2 or backward in accordance with FIG. 1. In the transport position both the outermost part 8 and the basic part 6 are located on top of the central part 7. In FIG. 2 the outermost part 8 is folded underneath the horizontal central part 7, for example in parallel thereto. The basic part 6 is also folded underneath the central part 7, for example in parallel thereto. In relation to each other, the outermost part 8 and the basic part 6 are, however, primarily located on opposite sides of the rotating base 9 and they extend substantially in parallel to each other. According to one embodiment of the invention, the outermost part 8 is folded next to the horizontal central part 7, for example in parallel thereto. Said outermost part 8 is shown in FIGS. 7 and 8. The first end of the outermost part 8 and the second end of the basic part 6 are located on opposite sides of the rotating base 9.

In view of the different uses of the lifting arm assembly and for the purpose of arranging it into the transport position, the lifting arm assembly 5 is dimensioned in such a manner that in the transport position the free distance of the rotating axis Y from the cabin 2 is wider than or substantially the same as the distance R between the outermost end of the lifting arm assembly 5 and said rotating axis Y. The term outermost end refers especially to the second end of the central part 7 or to the first end of the outermost part 8, when the outermost part 8 is also in the transport position according to FIG. 1 or 8. The term outer end also refers to the second end of the basic part 6 and to the first end of the central part 7, wherein the rotating axis Y and the rotating base 9 are positioned in the middle of the lifting arm assembly 5 and underneath the centre of the central part 7. The overall length of the lifting arm assembly 5 in the transport position is thus 2R. Said dimensioning makes it possible to turn the lifting arm assembly 5 into two different transport positions, but still the lifting arm assembly is positioned behind the cabin 2 and the overall length L of the vehicle does not change substantially.

As an example of the dimensioning of the other parts, it can be mentioned that the length of the basic part 6 is half of or less than half of the length of the central part 7 and the length of the outermost part 8 is less than half of the length of the central part 7. The outermost part 8 of FIG. 7 or 8 can also be slightly longer.

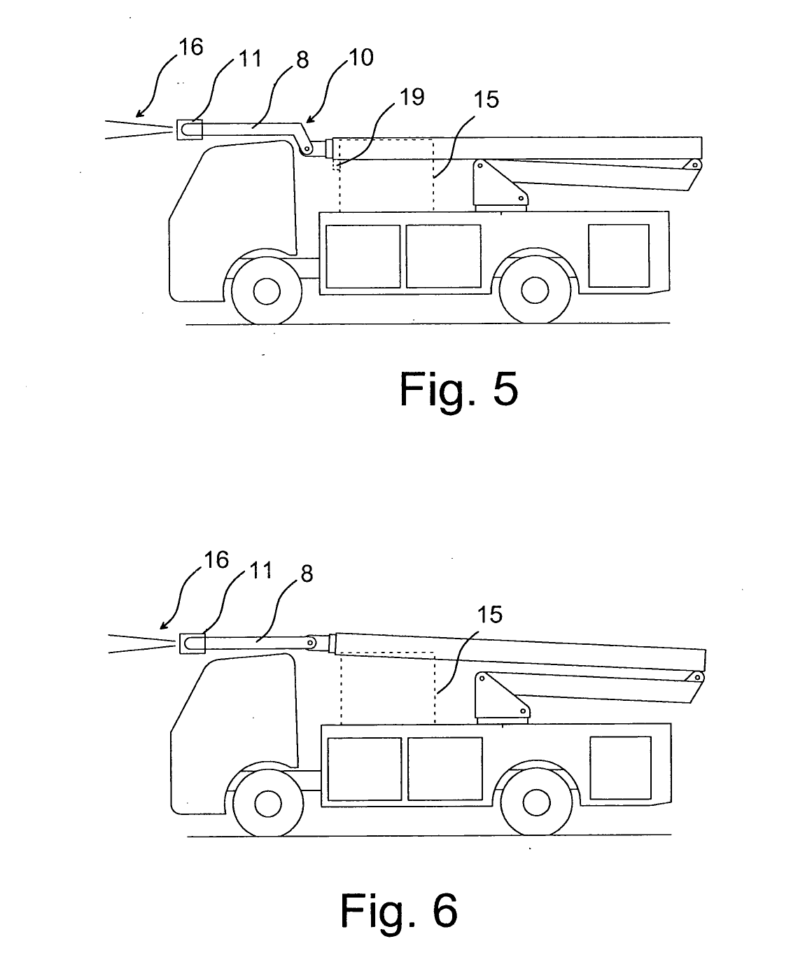

The embodiment of FIG. 5 illustrates the function of the outermost part 8, as in the transport position of the lifting arm assembly 5 the outermost part 8 can be outstretched into a standby position, i.e. position in which the outermost part 8 is located on top of the cabin 2. Thus, the outermost part 8 functions as an extension to the central part 7, for example in parallel to the central part 7. In the transport position the overall height of the lifting arm assembly 5 either complies the height H shown in FIG. 1 or it is higher than that. Reference is made especially to a rescue vehicle in which the standby position of the outermost part 8 enables rapid fire extinction action at the scene of fire without having to turn the outermost part 8 first. The outermost part 8 contains a spraying apparatus 11 known as such, which produces the necessary spray jet 16, for example a remote controlled hydraulic gun. The lifting arm assembly 5 functions as a fire extinction mast.

In order to be able to move the lifting arm assembly 5 to the transport position in accordance with FIG. 1 or 2, in which the height is restricted, the outermost part 8 is provided with a shape 10 by means of which the outermost part 8 rotates above the cabin and can be turned on top of the cabin 2, en though the other parts of the lifting arm assembly 5 were in their lowest position (maximum height H and transport position). The shape 10 is for example a turn, an angle, a curve, a fold or the like, or even a joint structure between the central part 7 and the outermost part 8, which lifts the central part 7 of the outermost part 8 higher and on top of the cabin 2 when the outermost part 8 is in an extended state. When a straight outer part 8 in accordance with FIG. 6 is used, the central part 7 must be raised slightly, if the overall height in the transport position is H. If the overall height of the lifting arm assembly 5 is greater than this, the arm assembly 5 may be in the low transport position, with the outermost part 8 outstretched.

The fire extinction tasks may continue in such a manner that the lifting arm assembly 5 is rotated around the rotating axis Y or it is lifted up. In these situations it is possibly necessary to take the support legs 14 in use as well.

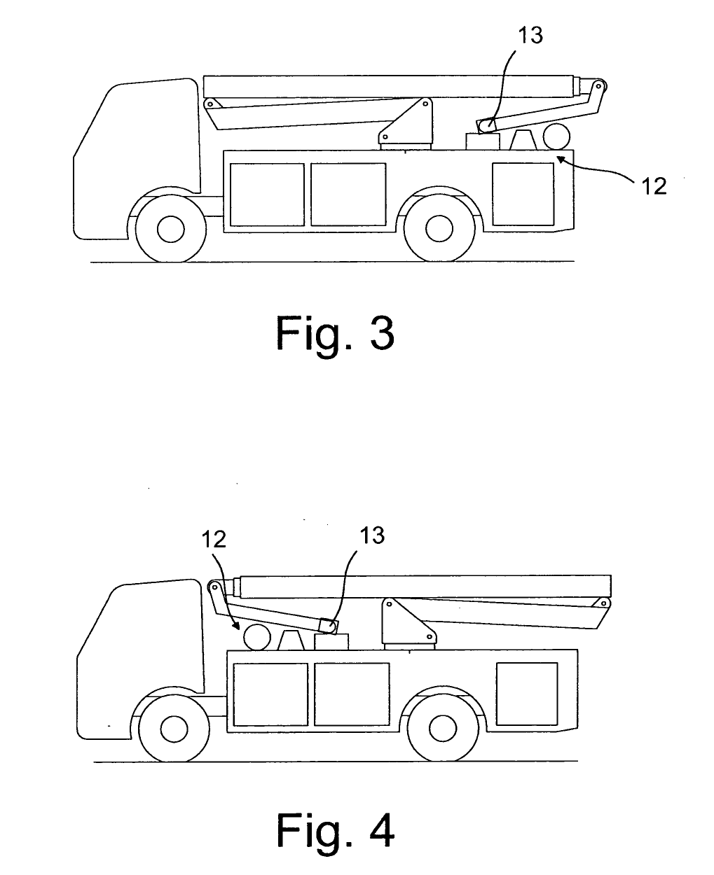

In the embodiment of FIG. 3, the vehicle equipped with a lifting arm assembly also comprises one or several replaceable work modules 12. It should also be noted that a lifting member 19, such as a lifting eye in accordance with FIG. 5 can also be fastened for example to the end of the central part 7, by means of which lifting member it is possible to lift and transfer various loads also at the scene of fire, for example by means of bands. The work modules 12, as well as the rescue or work cage either relate to the implementation of different stages of the same operation, or by means of them it is possible to use the vehicle in an entirely different operation. The work modules 12 are placed in the front or rear part of the bodywork 3, and so is the cage 15, as shown in FIG. 6, 8, 9 or 10.

The embodiment of FIGS. 5 and 6 is suitable especially for rescue vehicles, wherein the rescue cage 15 can be fastened to the outermost part 8 for example by means of quick clamping. Preferably, the outermost part 8 is equipped with quick clamping means for the work modules 12 and/or the cage 15.

In accordance with FIG. 10 the chassis structure 1 and the bodywork 3 do not reach as far backwards as the central part 7, wherein the outermost part 8 can be positioned behind the vehicle in an almost vertical position, although the rest of the lifting arm assembly 5 is in the transport position. The bodywork 3 is also of a shorter model, so that the cage 15 positioned in the rear part would not increase the length of the vehicle. The bodywork 3 may also contain a groove or a recess in which the cage 15 is positioned. This makes it possible to fasten the work modules 12 or the cage 15 to the outermost part 8 also in the rear of the vehicle. Thus, the cage 15 can be brought close to the vehicle, also down in the rear of the vehicle, wherein it is easy to move out of and into the cage.

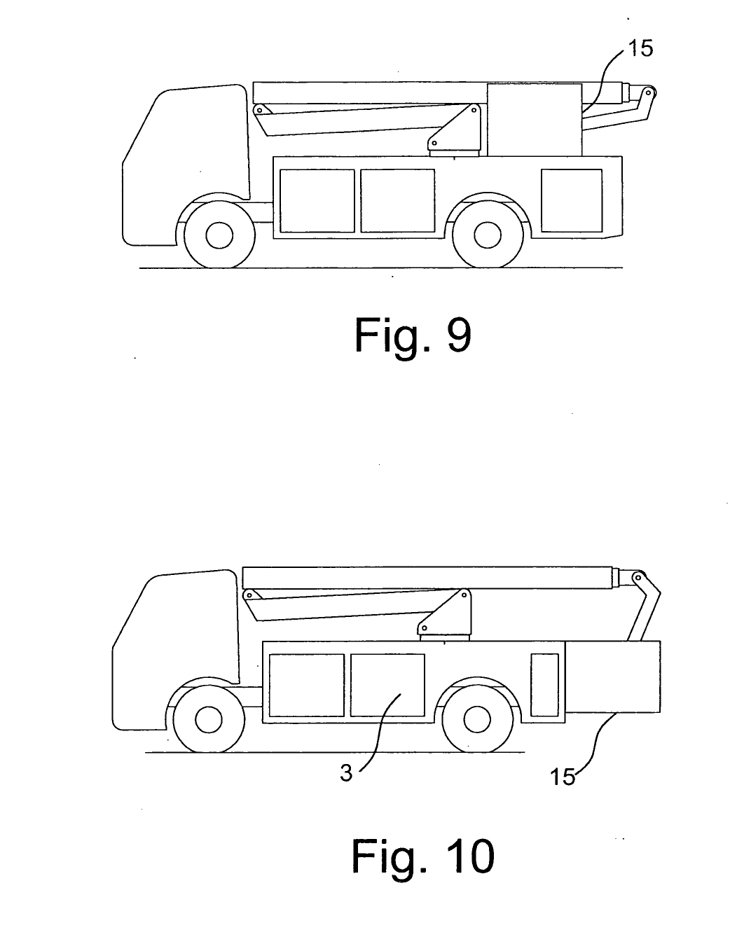

In one embodiment of the invention the cage 15 can be coupled to the outermost part 8 also in the transport positions of the lifting arm assembly 5 shown in FIGS. 8 and 9. Thus, the cage 15 is kept and transported at the side of the lifting arm assembly 5, for example on top of the bodywork 3.

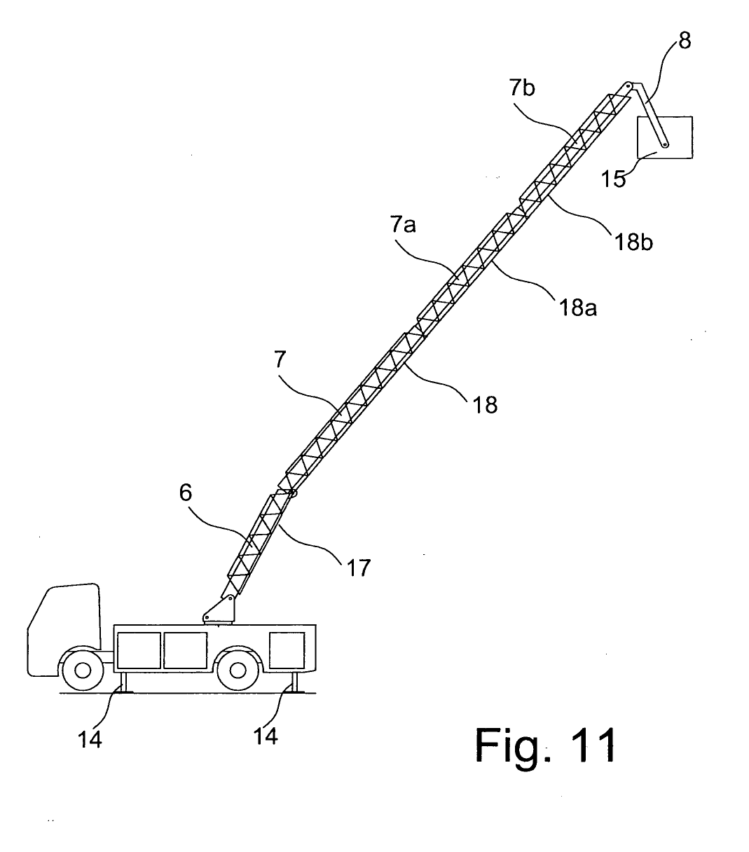

FIG. 11 shows an embodiment of the invention in which the telescopic extensions 7a and 7b of the central part 7 are outstretched. An ladder is fastened at the side of the lifting arm assembly 5, and its first part 17 is fastened to the basic part 6, the second extension 18 to the central part 7 and the telescopic parts 18a and 18b of the extension 18 are fastened to the telescopic extensions 7a and 7b of the central part 7. The parts 18, 18a and 18b move telescopically in relation to each other. If necessary, a rescue cage 15 is fastened to the outermost part 8. It is possible to extend the ladder straight, wherein the parts turn approximately 180 degrees.

The vehicle and its lifting arm assembly also comprise a control device by means of which the lifting arm assembly according to the invention is moved into desired positions. As a basis of the control device it is possible to use control devices known as such which are modified where necessary for the use in the lifting arm assembly of the presented kind. The control device for example controls the cylinders in a desired manner.

The invention is not restricted to the examples and embodiments disclosed above, which illustrate some special applications of the invention. If the aforementioned various properties are connected to the same lifting arm assembly and vehicle, a versatile basic version is attained, which is ready for a number of different tasks. For the manufacturing purposes and in view of the costs it is desirable that the apparatus comprises the basic functions and the lifting arm assembly has a certain basic geometry, which enable various tasks. The other equipment of the vehicle as well as the lifting arm assembly depend for example on the purpose of use. In this description the term vehicle refers generally especially to an apparatus moving on wheels, which is based on ready-made vehicle chassis, equipped for example with a box body or a bodywork and with a lifting arm assembly of the presented kind. The apparatus may also be based on frames and structures built for this purpose.

The invention can be modified in accordance with the appended claims.

1. A vehicle equipped with a lifting arm assembly and comprising:
a chassis structure with a cabin and a rotating base,
a lifting arm assembly fastened on top of the chassis structure so that it is capable of turning around a vertical rotating axis by means of the rotating base, wherein the lifting arm assembly comprises:
a first arm fastened to the rotating base and arranged to rotate in the vertical direction, and
a second arm fastened to the end of the first arm and arranged to rotate in the vertical direction in such a manner that in the transport positions of the lifting arm assembly the first arm can be turned underneath the second arm,
a third arm fastened to the end of the second arm and arranged to rotate in the vertical direction so that in the transport positions of the lifting arm assembly the third arm can be turned under the second arm or next to it, and the third arm can also be outstretched to a position in which it is located on top of the cabin, and equipped with a rescue and work cage,
wherein:
the second arm is telescopic, and
the lifting arm assembly is for the purpose of folding it into the transport positions dimensioned in such a manner that the lifting arm assembly in its entirety is positioned behind the cabin in those two transport positions in which the lifting arm assembly is parallel to the longitudinal axis of the vehicle, extending either forward or backward, and in said transport positions the height of the lifting arm assembly is greater than or substantially the same as the height of the cabin.

2. The vehicle according to claim 1, wherein the third arm comprises a shape enabling the holding of the third arm outstretched in said position also when the first arm and the second arm are in said transport position.

3. The vehicle according to claim 2, wherein the rescue or work cage can be kept on top of the chassis structure and it can be coupled to the third arm when the first arm and the second arm are in said transport position.

4. The vehicle according to claim 1, wherein the free distance between the cabin and said rotating axis is larger than or substantially the same as the free distance between the outermost end of the lifting arm assembly and said rotating axis when the lifting arm assembly is in said transport positions.

5. The vehicle according to claim 2, wherein the rotating base is positioned under the central part of the second arm when the lifting arm assembly is in said transport positions.

6. The vehicle according to claim 2, wherein one or several replaceable work modules are placed in the vehicle, which work modules can be fastened to the third arm containing quick clamping means.

7. The vehicle according to claim 1, wherein the third arm can be turned behind the vehicle so that the rescue or work cage is positioned behind the vehicle, when the first arm and the second arm are in said transport position.

8. A rescue vehicle equipped with a lifting arm assembly and comprising:
a chassis structure with a cabin, a bodywork and a rotating base,
a lifting arm assembly fastened on top of the chassis structure so that it is capable of turning around a vertical rotating axis by means of the rotating base, wherein the lifting arm assembly comprises:
a first arm fastened to the rotating base and arranged to rotate in the vertical direction, and
a second arm fastened to the end of the first arm and arranged to rotate in the vertical direction in such a manner that in the transport positions of the lifting arm assembly the first arm can be turned under the second arm,
a third arm fastened to the end of the second arm and arranged to rotate in the vertical direction so that in the transport positions of the lifting arm assembly the third arm can be turned under the second arm or next to it, and the third arm can also be outstretched to a standby position in which it is located on top of the cabin,
wherein:
the second arm is telescopic, and
the lifting arm assembly is for the purpose of folding it into the transport positions dimensioned in such a manner that the lifting arm assembly in its entirety is positioned behind the cabin in those two transport positions in which the lifting arm assembly is parallel to the longitudinal axis of the vehicle, extending either forward or backward, and in said transport positions the height of the lifting arm assembly is smaller than or substantially the same as the height of the cabin, and
the third arm is equipped with a spraying apparatus that can be used in said standby position.

9. The vehicle according to claim 1, wherein the third arm comprises a shape enabling the holding of the third arm outstretched in said standby position also when the first arm and the second arm are in said transport position.

10. The vehicle according to claim 9, wherein the bodywork contains one or several replaceable work modules that can be fastened to the third arm containing quick clamping means.

11. The vehicle according to claim 8, wherein a telescopic ladder is fastened next to the lifting arm assembly.

12. The vehicle according to claim 8, wherein the third arm can be turned behind the vehicle so that a cage can be fastened to the third arm, said arm being positioned behind the vehicle, when the first arm and the second arm are in said transport position.

13. A vehicle equipped with a lifting arm assembly and comprising:
a chassis structure with a cabin and a rotating base,
a lifting arm assembly fastened on top of the chassis structure in such a manner that it is capable of turning around a vertical rotating axis by means of the rotating base, wherein the lifting arm assembly comprises:
a first arm fastened to the rotating base and arranged to rotate in the vertical direction, and
a second arm fastened to the end of the first arm and arranged to rotate in the vertical direction in such a manner that in the transport positions of the lifting arm assembly the first arm can be turned under the second arm,
a third arm fastened to the end of the second arm and arranged to rotate in the vertical direction so that in the transport positions of the lifting arm assembly the third arm can be turned under the second arm or next to it, and the third arm can also be outstretched to a standby position in which it is located on top of the cabin,
wherein:
the second arm is telescopic, and
the lifting arm assembly is for the purpose of folding it into the transport positions dimensioned so that the lifting arm assembly in its entirety is positioned behind the cabin in those two transport positions in which the lifting arm assembly is parallel to the longitudinal axis of the vehicle, extending either forward or backward, and in said transport positions the height of the lifting arm assembly is smaller than or substantially the same as the height of the cabin.

14. The vehicle according to claim 13, wherein the third arm comprises at its end quick clamping means for work modules, a spraying apparatus or a rescue or work cage.

15. A lifting arm assembly comprising:
a rotating base by means of which the lifting arm assembly is capable of turning around a vertical rotating axis,
a first arm fastened to the rotating base and arranged to rotate in the vertical direction,
a second arm fastened to the end of the first arm and arranged to rotate in the vertical direction in such a manner that in the transport positions of the lifting arm assembly the first arm can be turned underneath the second arm,
a third arm fastened to the end of the second arm and arranged to rotate in the vertical direction so that in the transport positions of the lifting arm assembly the third arm can be turned under the second arm or next to it, and the third arm can also be outstretched to a position in which it functions as an extension to the second arm,
wherein:
the second arm is telescopic, and
for the purpose of folding it into transport positions the lifting arm assembly in its entirety is arranged to turn around said vertical rotating axis into two different transport positions which differ from each other 180°.

16. The lifting arm assembly according to claim 15, wherein the third arm comprises at its end quick clamping means for work modules, a spraying apparatus or a rescue or work cage.

17. The lifting arm assembly according to claim 15, wherein the rotating base is positioned under the central part of the second arm when the lifting arm assembly is in said transport positions.

18. The lifting arm assembly according to claim 15, wherein the third arm comprises a shape enabling the lifting of the third arm higher than the second arm when the third arm is outstretched to a position where it functions as an extension to the second arm.

19. The lifting arm assembly according to claim 15, wherein the lifting arm assembly is positioned on top of the chassis structure of a vehicle, in its entirety behind the cabin contained in the chassis structure, and dimensioned so that in said transport positions the height of the lifting arm assembly is smaller than or substantially the same as the height of the cabin.

20. The lifting arm assembly according to claim 19, wherein the third arm can be outstretched to a position in which it is located on top of the cabin.

21. The lifting arm assembly according to claim 15, wherein the lifting arm assembly is positioned on top of the chassis structure of the vehicle, behind the cabin contained in the chassis structure, and the third arm can be outstretched to a position in which it is located on top of the cabin.
